(19) United States
(12) Patent Application Publication
(10) Pub. No.: US 2013/0162689 A1
(43) Pub. Date: Jun. 27, 2013

(54) DISPLAY CONTROL APPARATUS AND METHOD

(71) Applicant: CANON KABUSHIKI KAISHA, Tokyo (JP)

(72) Inventor: Yohei Fujitani, Kawasaki-shi (JP)

(73) Assignee: CANON KABUSHIKI KAISHA, Tokyo (JP)

(21) Appl. No.: 13/676,306

(22) Filed: Nov. 14, 2012

(30) Foreign Application Priority Data
Dec. 27, 2011 (JP) 2011-286627

(51) Int. Cl. G09G 5/34

(52) U.S. Cl. CPC G09G 5/34
USPC 345/684; 345/682

(57) ABSTRACT

An apparatus comprises a reading unit which reads an intermediate image having a number of recording pixels smaller than that of a main image and larger than that of a thumbnail; and a control unit which controls, with regard to an image file to be displayed, such that, when the intermediate image is read, an image based upon the read intermediate image is displayed; and such that, when the intermediate image is not read, an image based upon a thumbnail in the image file is displayed if a main image in the image file to be displayed is equal to or greater than a predetermined size, and an image based upon the main image in the image file is displayed if the main image in the image file to be displayed is less than the predetermined size.

### BACKGROUND OF THE INVENTION

1. Field of the Invention

The present invention relates to a technique for controlling display of images.

2. Description of the Related Art

In order to improve read-out and display speed of captured image data at the time of reproduction, recent digital cameras come equipped with a feature that records main image data, intermediate image data and thumbnail image data in a single image file.

However, since an image file captured using an older digital camera will not contain an intermediate image, it is necessary to display a substitute image in place of the intermediate image when such an image file not containing an intermediate image is displayed.

Accordingly, in Japanese Patent Laid-Open No. 2006-005952, an image file is detected, with thumbnail image data being detected first followed by main image data, and the detected image data is then reproduced as the substitute image.

In a case where the main image is displayed in place of an intermediate image, as in Japanese Patent Laid-Open No. 2006-005952 cited above, display processing takes time and this invites a decline in response when the size of the image data is large. Conversely, in a case where a thumbnail image is displayed in place of an intermediate image, an image the resolution of which is inferior to that of the intermediate image will be displayed if, for example, the image is displayed upon being enlarged.

### SUMMARY OF THE INVENTION

The present invention has been made in consideration of the aforementioned problem and realizes a technique whereby, when an image file not having an intermediate image is displayed, the main image is used to present a display the quality whereof is higher than that of the thumbnail image while, on the other hand, the thumbnail image is used to present a display with a response quicker than that obtained with the main image.

In order to solve the aforementioned problems, the present invention provides a display control apparatus comprising: a reading unit configured to read an intermediate image, which has a number of recording pixels smaller than that of a main image and larger than that of a thumbnail image, from an image file; and a display control unit configured to perform control, with regard to an image file to be displayed, in such a manner that, in a case where the intermediate image is read by the reading unit, an image based upon the read intermediate image is displayed on a display unit; and in such a manner that, in a case where the intermediate image is not read by the reading unit, an image based upon a thumbnail image included in the image file is displayed on the display unit if a main image in the image file to be displayed is equal to or greater than a predetermined size, and an image based upon the main image included in the image file is displayed on the display unit if the main image in the image file to be displayed is less than the predetermined size.

In order to solve the aforementioned problems, the present invention provides a method of controlling display in an apparatus which displays an image, comprising: a reading step of reading an intermediate image, which has a number of recording pixels smaller than that of a main image and larger than that of a thumbnail image, from an image file; and a display control step of performing control, with regard to an image file to be displayed, in such a manner that, in a case where the intermediate image is read at the reading step, an image based upon the read intermediate image is displayed on a display unit; in such a manner that, in a case where the intermediate image is not read at the reading step, an image based upon a thumbnail image included in the image file is displayed if a main image in the image file to be displayed is equal to or greater than a predetermined size, and an image based upon the main image included in the image file is displayed if the main image in the image file to be displayed is less than the predetermined size.

According to the present invention, when an image file not having an intermediate image is displayed, the main image can be used to present a display the quality whereof is higher than that of the thumbnail image while, on the other hand, the thumbnail image can be used to present a display with a quicker higher than that obtained with the main image.

Further features of the present invention will become apparent from the following description of exemplary embodiments (with reference to the attached drawings).

### BRIEF DESCRIPTION OF THE DRAWINGS

FIG. 1 is an external view of a display control apparatus according to an embodiment of the present invention;

FIG. 2 is a block diagram of the display control apparatus according to this embodiment;

FIG. 3 is a diagram exemplifying the composition of an image file;

FIG. 4 is a flowchart of processing in a reproduction mode according to this embodiment;

FIG. 5 is a flowchart of file analysis processing, which is one step in the flowchart of FIG. 4; and

FIG. 6 is a flowchart of image display processing, which is one step in the flowchart of FIG. 4.

### DESCRIPTION OF THE EMBODIMENTS

A preferred embodiment of the present invention will now be described in detail with reference to the accompanying drawings.

<Apparatus Configuration>

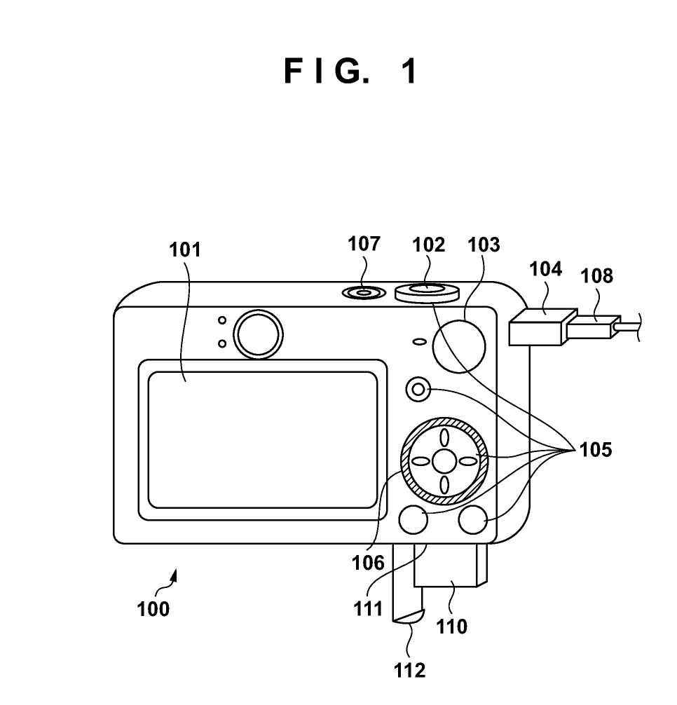

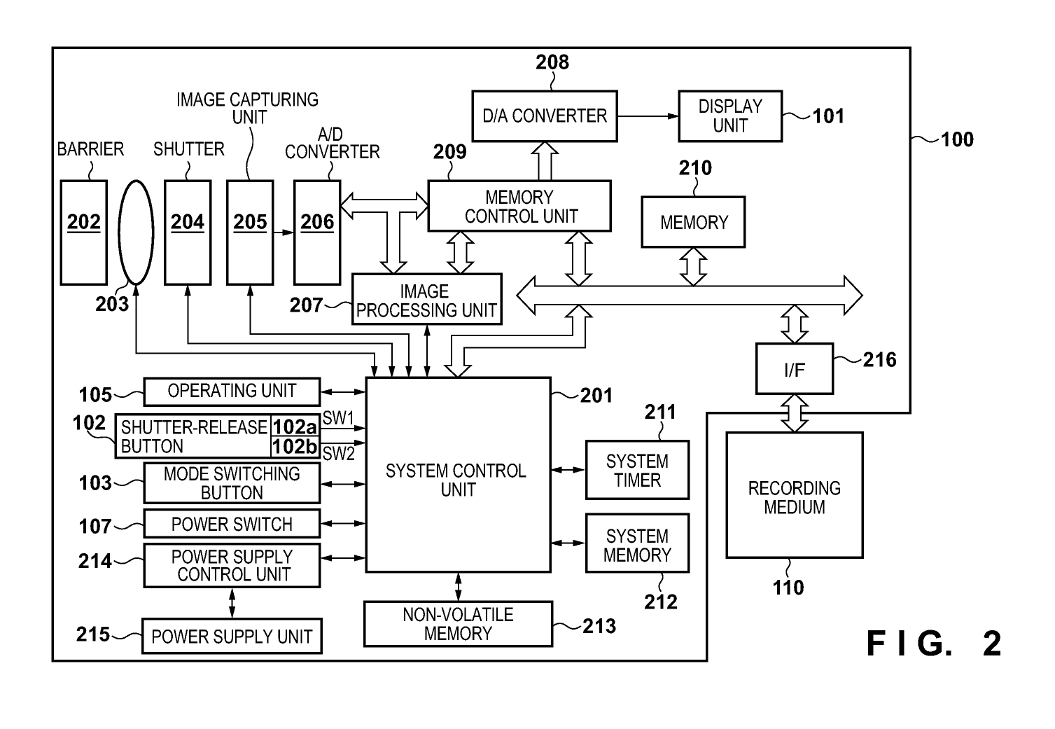

Reference will be had to FIGS. 1 and 2 to describe the functions and external appearance of an image capturing apparatus (a digital camera is taken as an example thereof in this embodiment) according to this embodiment to which the display control apparatus of the present invention is applied.

In FIG. 1, a display unit 101 displays images and various information. A shutter-release button 102 is an operating unit for shooting. A mode switching button 103 is an operating unit for changing over among various modes. A connector 104 is an interface that connects a connection cable 108 with a digital camera 100. Operating units 105 comprise operating members such as various switches, buttons and a touch panel operated in various ways by the user. A controller wheel 106 is a rotatable operating member included among the operating units 105. A power switch 107 switches between power on and power off. A recording medium 110 is a medium such as a memory card or hard disk. A recording medium slot 111 is for accommodating the recording medium 110. The recording medium 110 accommodated in the recording medium slot 111 makes it possible to communicate with the digital camera 100. A cover 112 covers the recording medium slot 111.

FIG. 2 is a block diagram exemplifying the configuration of the digital camera 100 according to this embodiment.

In FIG. 2, a photographing lens 203 includes a zoom lens and a focusing lens. A shutter 204 has a diaphragm function. An image capturing unit 205 is an image sensor, which is constituted by a CCD or CMOS or the like, for converting the optical image of a subject to an electric signal. An A/D converter 206 converts an analog signal to a digital signal. The A/D converter 206 is used to convert an analog signal, which is output from the image capturing unit 205, to a digital signal. A barrier 202 covers the image capturing system (which includes the photographing lens 203) of the digital camera 100, thereby preventing contamination of and damage to the image capturing system that includes the photographing lens 203, shutter 204 and image capturing unit 205.

An image processing unit 207 subjects the data from the A/D converter 206 or data from a memory control unit 209 to predetermined pixel interpolation, resize processing such as size reduction and color conversion processing. Further, the image processing unit 207 executes predetermined processing using captured image data, and a system control unit 201 controls exposure and rangefinding based upon the obtained result of the processing. As a result, TTL (through-the-lens)-type AF (auto-focus) processing, AE (auto-exposure) processing and EF (pre-flash) processing is executed. The image processing unit 207 executes predetermined processing using the captured image data and TTL-type AWB (automatic white balance) processing based upon the obtained result of processing.

The output data from the A/D converter 206 is written directly to the memory 210 via the image processing unit 207 and memory control unit 209 or via the memory control unit 209. The memory 210 stores image data obtained by the image capturing unit 205 and then converted to digital data by the A/D converter 206 and stores image data for display on the display unit 101. The memory 210 has enough capacity for storing a predetermined number of still images, moving images that extend over a predetermined period of time, and audio.

Further, the memory 210 serves also as an image display memory (a video memory). A D/A converter 208 converts image data, which has been stored in the memory 210, to an analog signal and supplies the analog signal to the display unit 101. The display image data thus written to the memory 210 is displayed by the display unit 101 via the D/A converter 208. The display unit 101 presents a display, which conforms to the analog signal from the D/A converter 208, on a display device such as an LCD. The digital signal obtained by the A/D conversion in the A/D converter 206 and stored in the memory 210 is converted to an analog signal in the D/A converter 208 and the analog signal is sequentially transferred to and displayed by the display unit 101. The display unit 101 thus functions as an electronic viewfinder and presents a through-the-lens display.

A non-volatile memory 213 is a memory that can be recorded on and erased electrically and an EEPROM or the like can be used for this memory. Constants and a program and the like for operating the system control unit 201 are stored in the non-volatile memory 213. The program referred to here is a program for executing the processing of various flowcharts, described below, according to this embodiment.

The system control unit 201 controls the overall digital camera 100. The system control unit 201 implements the processing of this embodiment, described below, by running the program that has been recorded in the non-volatile memory 213. A system memory 212 uses a RAM. Constants and variables for operating the system control unit 201 and the program read out from the non-volatile memory 213 are expanded in the system memory 212. Further, the system control unit 201 performs display control by controlling the memory 210 and units such as the D/A converter 208 and display unit 101.

A system timer 211 is a timekeeping unit for measuring the time used for each control operation and the time kept by an internal clock.

The mode switching button 103, a first shutter switch 102a, a second shutter switch 102b and operating unit 105 constitute operating means for inputting various operating instructions to the system control unit 201.

The mode switching button 103 changes over the operating mode of the system control unit 201 to any one mode among modes such as a still image recording mode, moving image recording mode and reproduction mode. The still image recording mode includes an automatic shooting mode, an automatic scene determination mode, a manual mode, various scene modes that establish shooting settings according to the shooting scene, a program AE mode and a custom mode. Any of these modes included in the still image shooting mode is changed over to directly by using the mode switching button 103. Alternatively, it may be arranged so that once the changeover to the still image shooting mode is made by using the mode switching button 103, any of the modes included in the still image shooting mode is switched to using another operating member. Similarly, the moving image shooting mode may include a plurality of modes. The first shutter switch 102a is turned ON when operation of the shutter-release button 102 provided on the digital camera 100 is in mid-course, or namely when the shutter button is pressed half way (which indicates a preliminary shooting instruction), thereby generating a first shutter switch signal SW1. Operations such as AF (auto-focus) processing, AE (auto-exposure) processing, AWB (automatic white balance) processing and EF (pre-flash) processing are started by the first shutter switch signal SW1.

The second shutter switch 102b is turned ON upon completion of operation of the shutter-release button 102, or namely when the shutter button is pressed fully (which indicates a shoot instruction), thereby generating a second shutter switch signal SW2. A series of shooting processes from signal readout from image capturing unit 205 to writing of image data to the recording medium 110 is started by the second shutter switch signal SW2.

By selecting various functions icons displayed on the display unit 101, the operating members of operating unit 105 are assigned appropriate functions for each situation and thus act as various function buttons. Examples of these function buttons area an end button, a back button, an image scrolling button, a jump button, a narrow-down button and an attribute change button. For example, a menu screen that enables various settings to be made is displayed on the display unit 101 by pressing a menu button. The user can make various settings intuitively by using the menu screen, which is displayed on the display unit 101, four-direction (up, down, left, right) buttons and a SET button.

The controller wheel 106, which is a rotatable operating member included among the operating units 105, is used together with the direction buttons as when a selection item is specified. When the controller wheel 106 is turned, an electrical pulse signal is generated in accordance with the amount of rotation, and the system control unit 201 controls each unit of the digital camera 100 based upon the pulse signal. The angle through which the controller wheel 106 has been turned and how many times it has been turned can be determined by the pulse signal. It should be noted that the controller wheel 106 can be any operating member so long as it is an operating member whose rotation can be detected. For example, it can be a dial operating member in which the controller wheel 106 per se is rotated to generate the pulse signal in accordance with a turning operation by the user. Further, it can be a device (a so-called touch wheel) that detects an operation such as the revolution of the user's finger on the controller wheel 106 without by controller wheel 106 itself being rotated.

A power supply control unit 214, which is constituted by such means as a battery detection circuit, a DC-DC converter and a switch circuit for changing over the block to be supplied with power, detects a battery has been installed or not, the type of battery and the residual capacity thereof. On the basis of the results of such detection and instructions from the system control unit 201, the power supply control unit 214 supplies the necessary voltage for the necessary length of time to each of the units inclusive of the recording medium 110.

A power supply unit 215 comprises a primary battery such as an alkali battery or lithium battery, a secondary battery such as an NiCd battery, NiMH battery or Li battery, an AC adapter and the like. A recording medium interface 216 is for interfacing with the recording medium 110 such as the memory card or hard disk. The recording medium 110, such as a memory card for recording captured images, is constituted by a semiconductor memory or magnetic disk or the like.

It should be noted that the digital camera has a touch panel, which is capable of sensing that the display unit 101 is touched, as one operating unit 105. The touch panel and the display unit 101 can be constructed as a single integrated unit. For example, the touch panel is constructed in such a manner that the transmittance of light will not interfere with the display presented by the display unit 101, and it is attached to the uppermost layer of the display face of the display unit 101. In addition, input coordinates on the touch panel and display coordinates on the display unit 101 are correlated. As a result, a GUI can be constructed that makes it possible for the user to directly manipulate the screen displayed on the display unit 101. The system control unit 201 is capable of detecting the following operations performed by contacting the touch panel: touching of the panel using a finger or pen (referred to as “touch down” below); a state in which the touch panel is in contact with a finger or pen (referred to as “touch on” below); movement of a finger or pen while in contact with the touch panel (referred to as “move” below); lifting of a finger or pen that has been in contact with the touch panel (referred to as “touch up” below); and a state in which the touch panel is not being touched at all (referred to as “touch off” below). These operations and position coordinates at which the touch panel is being touched by the finger or pen are communicated to the system control unit 201 through an internal bus and, based upon the information thus communicated, the system control unit 201 determines what kind of operation was performed on the touch panel. As for “move”, the determination can be made also for every vertical component and horizontal component with regard to the direction of movement of the finger or pen, which is moved on the touch panel, based upon a change in the coordinate position. Further, it is assumed that a stroke has been made when “touch up” is performed following a regular “move” after a “touch down” on the touch panel. A very quick stroke action is referred to as a “flick”. A “flick” is an operation in which, with fingers in contact with the touch panel, the fingers are moved rapidly over a certain distance and then lifted. In other words, this is a rapid tracing operation in which the fingers are flicked across the surface of the touch panel. The system control unit 201 can determine that a “flick” has been performed when it detects such movement over a predetermined distance or greater and at a predetermined speed or greater and then detects “touch up”. Further, the system control unit 201 can determine that “drag” has been performed if it detects movement over a predetermined distance or greater at a speed less than a predetermined speed. It should be noted that the touch panel may employ a method that relies upon any of the following: resistive film, electrostatic capacitance, surface acoustic waves, infrared radiation, electromagnetic induction, image recognition and optical sensing.

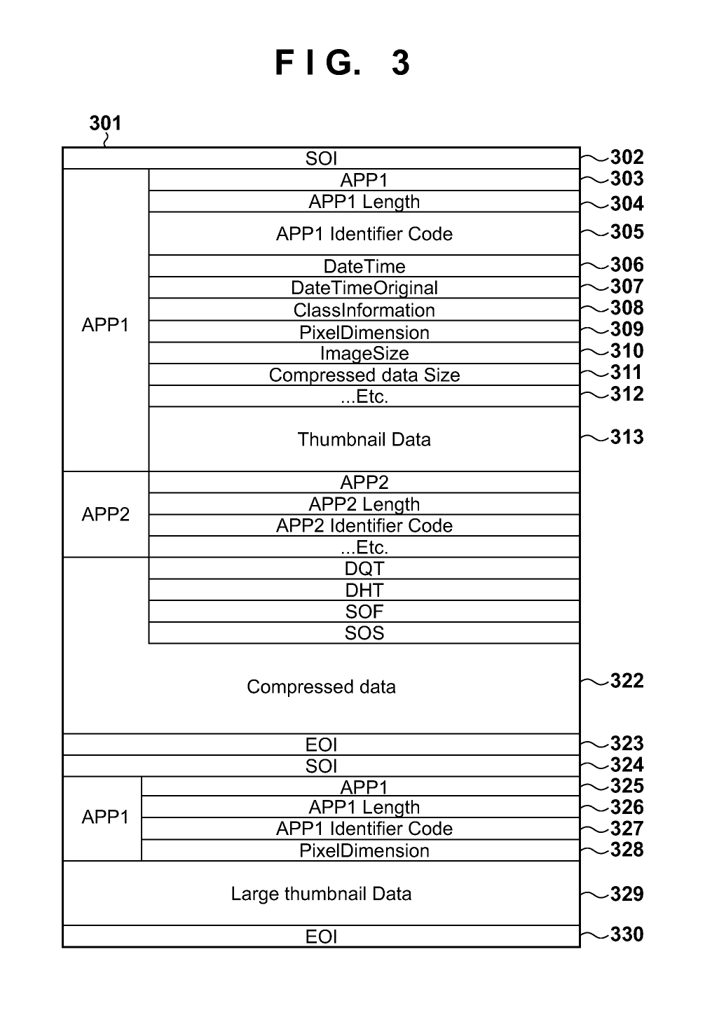

FIG. 3 is a diagram exemplifying the composition of an image file captured and generated by the digital camera 100.

In FIG. 3, image data 301 has a marker SOI (302) at the top thereof indicating the beginning of an image, as well as application markers APP1 (303) and APP2. The application marker APP1 (303) consists of size (304) of the APP1; an identification code (305) of APP1; DateTime (306) indicating the creation date and time of the image data; DateTimeOriginal (307) indicating the date and time at which the image data was generated; ClassInformation (308) indicating class information; PixelDimension (309) indicating number of recording pixels of the main image, described later; ImageSize (310) indicating recording size setting; Compressed data Size (311) indicating the size (data capacity) of the recorded main image, described later; other shooting information (312); the above-mentioned thumbnail image (313); the main image (322); and a marker EOI (323) indicating end of the image. The main image (322) is an image the number of recording pixels of which differs depending upon a recording size setting and setting of aspect ratio, described later. It is assumed here that the thumbnail image (313) is an Exif-format DCF thumbnail and that the number of recording pixels thereof is a uniform 160 pixels×120 pixels.

Further, in accordance with a selection operation on the menu screen, described later, data is attached and is composed of a marker SOI (324) indicating the beginning of an image; a application marker APP1 (325); an intermediate image (329), which is image data having a size intermediate the main image and thumbnail image; and a marker EOI (330) indicating end of the image. Included within the application marker APP1 (325) are size (326) of the application marker; an identification code (327) of APP1; and PixelDimension (328) indicating the number of recording pixels of the intermediate image.

The digital camera 100 is capable of setting the recording size to any one of L, M1, M2 and S, in accordance with user operation at shooting time, as one of the shooting conditions. When an image is captured and an image file generated, the image size setting that has been made is recorded in ImageSize (310) of the generated image file. Further, the number of recording pixels is recorded in PixelDimension (309).

Further, in accordance with a selection made by the user, the digital camera 100 is capable of setting the aspect ratio of an image that will be captured. Examples of settable aspect ratios are 4:3, 16:9, 3:2, 1:1 and 4:5.

The number of recording pixels is decided in accordance with each recording size setting and the aspect-ratio setting that is in effect at shooting time. For example, see the corresponding relationships in the table below. It should be noted that, with regard to the number of recording pixels in accordance with the “L” recording size setting, the number depends upon the maximum number of recording pixels specific to the image capturing apparatus and therefore differs depending upon the camera model.

| SET | | NUMBER OF RECORDING PIXELS BY | | | | |
|---|---|---|---|---|---|---|
| RECORDING | APPLIED | SETTABLE ASPECT RATIO (W × H) | | | | |
| SIZE | GUIDELINE | 4:3 | 16:9 | 3:2 | 1:1 | 4:5 |
| L | PRINT OUT | 3648 × 3648 | 3648 × 2048 | 3648 × 2432 | 2736 × 2736 | 2192 × 2736 |
| | TO A2 | | | | | |
| | PAPER | | | | | |
| M1 | PRINT OUT | 2816 × 2112 | 2846 × 1584 | 2816 × 1880 | 2112 × 2112 | 1696 × 2112 |
| | TO A3 | | | | | |
| | PAPER | | | | | |
| M2 | PRINT OUT | 1600 × 1200 | 1920 × 1080 | 1600 × 1064 | 1200 × 1200 | 960 × 1200 |
| | UP TO 2L- | | | | | |
| | SIZE | | | | | |
| | PAPER; | | | | | |
| | MONITOR | | | | | |
| | DISPLAY | | | | | |
| | WITH FULL | | | | | |
| | HIGH- | | | | | |
| | VISION | | | | | |
| | (FULL HD) | | | | | |
| | QUALITY | | | | | |
| S | VGA- | 640 × 480 | 640 × 360 | 640 × 424 | 480 × 480 | 384 × 480 |
| | QUALITY | | | | | |
| | MONITOR | | | | | |
| | DISPLAY | | | | | |

There are also cases where, aside from the above-mentioned recording size setting that can be made by the user, recording is performed upon making “M” the recording size setting automatically because, depending upon the shooting mode, the user may not be able to select the recording size setting. If the aspect ratio is 4:3, then M is 1984×1488, by way of example.

Further, it is also possible to resize an already captured image. When an image is to be resized, this can be achieved by selecting a recording size setting smaller than the present recording size setting of the captured image or any recording size setting from within XS, which is smaller than S. Here XS is 320×240 pixels, by way of example. The number of recording pixels after resizing of the image is recorded in PixelDimension (309) of the resized-image file, and the recording size setting selected at the time of resizing is recorded in ImageSize (310), which indicates the recording size setting.

Further, if, at the time shooting and at the time of resizing, the recording size settings are L and M1, respectively, an intermediate image obtained by reducing the size of the main image is generated and this is recorded in the image file as the intermediate image (320). The number of recording pixels of the intermediate image is decided in accordance only with the setting of the aspect ratio and irrespective of the recording size setting. For example, the number of recording pixels of the intermediate image is 1440×1080 pixels if the aspect ratio is 4:3 and 1620×1080 pixels if the aspect ratio is 3:2. The intermediate image is thus recorded in the image file in a case where shooting or resizing has been performed by the digital camera 100. However, if an image is not an image that has been captured by the digital camera 100, there will be cases where an intermediate image will not exist even if the recording size setting is L or M1.

This embodiment is such that if, when an image is to be displayed, an intermediate image does not exist for the situation that is supposed to use an intermediate image, reference is had to the recording size setting and the thumbnail image (313) is displayed in place of the intermediate image if the setting is L or M1 or M. Further, in case of another recording size setting (a recording size setting smaller than L or M1 or M), the main image (322) is displayed instead of the intermediate image. The details of this processing will be described below.

[Processing in Reproduction Mode]

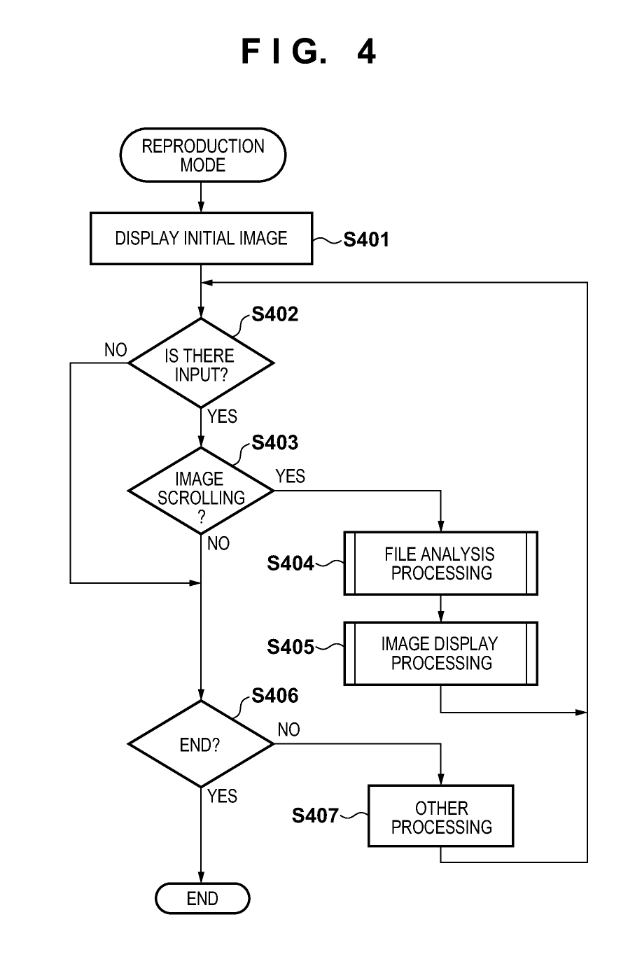

Processing in the reproduction mode will now be described with reference to the flowchart of FIG. 4. This processing is implemented by expanding the program, which has been stored in the non-volatile memory 213, in the system memory 212 and having the system control unit 201 execute the program.

When the digital camera 100 is started and the reproduction mode is established, processing in the reproduction mode of FIG. 4 starts.

At step S401, the system control unit 201 reads in the latest image or resumption image from the recording medium 110 and displays it on the display unit 101.

At step S402, the system control unit 201 determines whether there is an input. Here the term “input” includes user operations with respect to the operating members of the operating unit 105, events that notify of opening and closing of the battery cover and of a decline in supplied power, etc. Process proceeds to step S406 if there is no input and to step S403 if there is an input.

At step S403, the system control unit 201 determines whether the input at step S402 is an image scrolling operation. Operations determined to be an image scrolling operation include pressing of the left or right button of the four-direction buttons included in the operating unit 105, turning of the controller wheel 106, and a flick operation or drag operation to the left or right with regard to the touch panel included in the operating unit 105. In any of these cases, process proceeds to step S404. Otherwise, process proceeds to step S406.

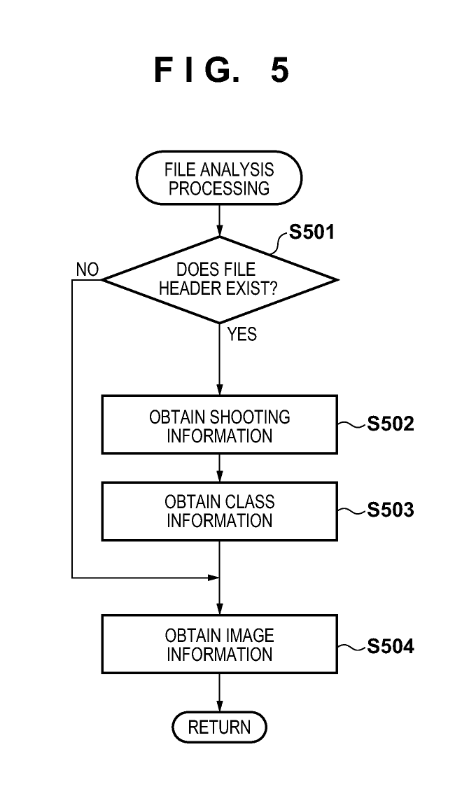

At step S404, the system control unit 201 executes file analysis processing of the image displayed anew by image scrolling. The details of file analysis processing will be described later with reference to FIG. 5.

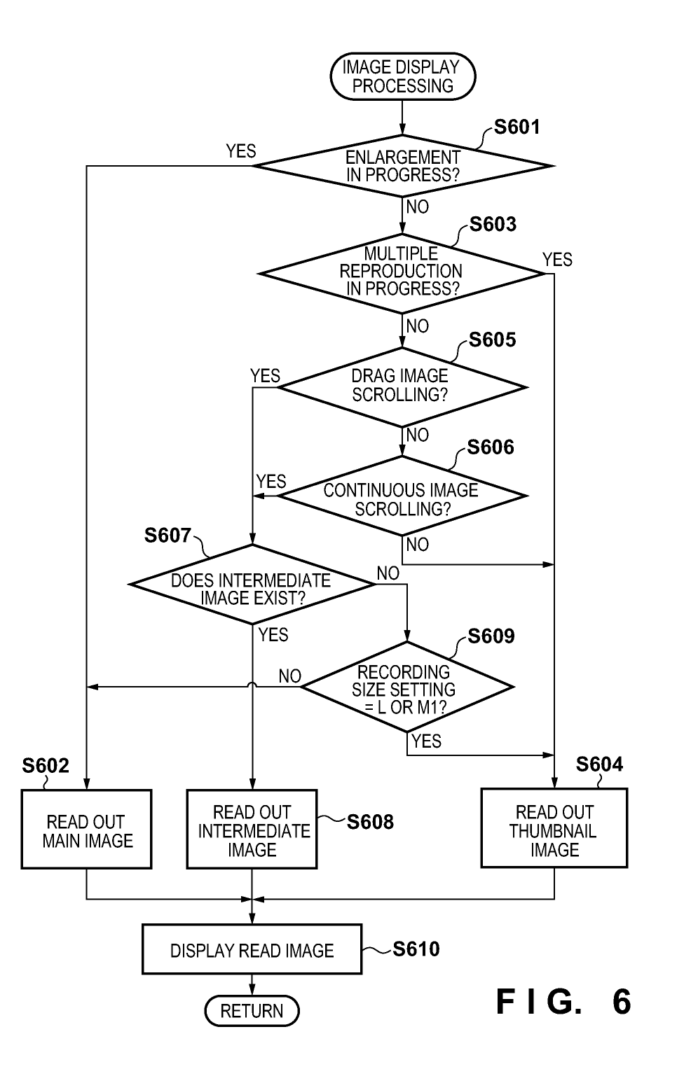

At step S405, the system control unit 201 executes image display processing for displaying the image displayed anew by image scrolling. The details of image display processing will be described later with reference to FIG. 6. When image display processing ends, process returns to step S402.

At step S406, the system control unit 201 determines whether there has been an event that ends the reproduction mode. Example of such an ending event are an operation for changing over to another operating mode, such as the shooting mode, and turning off of the power supply, etc. If an ending event has occurred, reproduction is terminated. If an ending event has not occurred, then process proceeds to step S407.

At step S407, the system control unit 201 executes other processing conforming to various inputs. This other processing can be processing for changing over from single reproduction, which is for displaying a single image on the display unit 101, to multiple reproduction that displays a plurality of images simultaneously, or for enlarging an image, which is being displayed on the display unit 101, and shifting to an enlarge mode. Other examples are processing for deleting an image that is being displayed, processing for appending attribute information such as a protection attribute or class information, and the above-mentioned resize processing conforming to user operation. When the processing at step S407 ends, process returns to step S402. If there is no event whatsoever, no particular processing is executed, step S407 is skipped and process returns to step S5402.

[File Analysis Processing]

The File Analysis Processing at Step S404 in FIG. 4 will be described with reference to the flowchart of FIG. 5. This processing is implemented by expanding the program, which has been stored in the non-volatile memory 213, in the system memory 212 and having the system control unit 201 execute the program.

At step S501, the system control unit 201 determines whether the file to be analyzed has a file header in which attribute information such as shooting information and class information is described. The file under analysis is the file of an image displayed anew by image scrolling. If it is determined that the file has a file header in which attribute information such as shooting information and class information is described, process proceeds to step S502. Otherwise, process proceeds to step S504.

The system control unit 201 obtains shooting information from the file header at step S502 and obtains class information from the file header at step S503. Here the shooting information is information relating to shooting date and time and information such as the shooting mode that prevailed at the time of shooting. On the other hand, the class information is identification information for use in image search and signifies tag information or the like.

Next, at step S504, the system control unit 201 obtains information relating to the file format of the image, as well as information, extracted based upon the file format, concerning the main image data such as the starting position of the main image, the starting position of the intermediate image and the image compression method and the like.

[Image Display Processing]

The image display processing at step S405 of FIG. 4 will now be described. This processing is implemented by expanding the program, which has been stored in the non-volatile memory 213, in the system memory 212 and having the system control unit 201 execute the program.

At step S601, the system control unit 201 determines whether an enlarged display is in effect (whether the enlarging mode is in effect). If an enlarged display is being presented, process proceeds to step S602, the main body of the image data (322) is read out and the system control unit 201 executes display processing such as decoding. This is followed by step S610, at which the system control unit 201 displays the image data, which has been read out at step S602, on the display unit 101 upon enlarging the image data in accordance with the enlargement ratio and enlargement position that prevailed prior to image scrolling. Thus, during enlargement, image scrolling is performed with the image displayed in enlarged form and therefore a high resolution is required. Accordingly, the main body of the image (referred to as the “main image” below) is displayed and not an intermediate image or a thumbnail image. If it is determined at step S601 that enlargement is not in effect, then process proceeds to step S603.

At step S603, the system control unit 201 determines whether multiple reproduction is in progress. If it is determined that multiple reproduction is in progress, process proceeds to step S604, thumbnail images are read out and the system control unit 201 executes display processing such as decoding. This is followed by step S610, at which the system control unit 201 arrays and displays the plurality of thumbnail images, which have been read out at step S604, on the display unit 101 (multiple reproduction). Thus, with multiple reproduction, a high resolution is not required because multiple images are displayed upon being reduced in size. On the other hand, since multiple images are displayed simultaneously, it is necessary to process many images rapidly so as not to invite diminished response. Accordingly, during multiple reproduction, thumbnail images are displayed rather than the main images or intermediate images. It should be noted that in case of image scrolling not accompanied by screen changeover in multiple reproduction, the processing of steps S604 and S610 are omitted and a selection frame, which indicates the images selected during multiple reproduction, is merely moved to the preceding or following image in accordance with the image scrolling operation.

At step S605, the system control unit 201 determines whether the image scrolling operation determined at step S403 is drag image scrolling (dragging in the left-right direction with respect to the touch panel included in the operating unit 105). If drag image scrolling is determined, process proceeds to step S607. Otherwise, process proceeds to step S606. Drag image scrolling requires that an image be moved and displayed while following up movement based upon the dragging operation. Accordingly, both a high resolution and quick response are required. Therefore, in order to present a display utilizing an intermediate image that can be displayed with a resolution higher than that of a thumbnail image and without imposing a processing load greater than that of the main image, process proceeds to step S607 in the case of drag image scrolling.

At step S606, the system control unit 201 determines whether the image scrolling operation determined at step S403 of FIG. 4 is a continuous image scrolling operation. A continuous image scrolling operation includes the following operations: an operation in which the right or left button of the four-direction arrow buttons included in the operating unit 105 is held depressed an extended period of time (pressed continuously in excess of a predetermined period of time), and an operation in which the controller wheel 106 is turned rapidly (more specifically, an operation in which the controller wheel is rotated in excess of a predetermined angle within a predetermined period of time). In case of the continuous image scrolling operation in single reproduction, both a high resolution in order to determine whether image scrolling has been performed up to the intended image and a quick response for performing image scrolling to the next image rapidly are required. Therefore, in order to present a display utilizing an intermediate image that can be displayed with a resolution higher than that of a thumbnail image and without imposing a processing load greater than that of the main image, process proceeds to step S607 in case of the continuous image scrolling operation. Otherwise, process proceeds to step S604. On the other hand, in a case where it is determined at step S606 that the operation is not the continuous image scrolling operation, one example of operation is single-image scrolling based upon depression, for a short period of time, of the right or left button of the four-direction arrow buttons in the operating unit 105 in the single reproduction mode (namely an operation in which the button is pressed and then, within a predetermined period of time, released). In the case of single-image scrolling, process proceeds to step S604 and a thumbnail is displayed. However, this is transition processing up to display of the main image; after the thumbnail image is displayed, the main image is displayed in place of thumbnail image upon completion of processing such as decoding for displaying the main image. That is, since the main image of highest resolution is displayed in any event, the rapidly processable thumbnail image is displayed without a high resolution being required for the image displayed as the transition prior to the display of main image.

At step S607, the system control unit 201 determines whether an intermediate image has been recorded as the image to be displayed. This can be determined in accordance with whether an intermediate image starting position could be obtained at step S504 in FIG. 5 described above. If an intermediate image has been recorded, process proceeds to step S608, the intermediate image is read out, and the intermediate image is displayed at step 610. Process proceeds to step S609 if there is no intermediate image.

At step S609, the system control unit 201 refers to ImageSize (310) indicating the above-mentioned recording size setting included in the image file and determines whether the recording size setting is L, M1 or M. If the setting is L, M1 or M, process proceeds to step S604 and the system control unit 201 performs control so as to display the thumbnail image. If the setting is not L, M1 or M, then process proceeds to step S602 and the system control unit 201 performs control so as to display the main image. Thus, in a case where there is no intermediate image in a situation in which an intermediate image is to be displayed, a thumbnail image is displayed in place of the intermediate image if the recording size setting is L, M1 or M. The reason for this is that, if the recording size setting of the main image is greater than M (or in other words, greater than a predetermined size), then the setting will be too high in comparison with the number of recording pixels of the intermediate image, which is a fixed value in accordance with the aspect ratio, display processing would take too much time and this would invite a decline in response.

Further, in a case where there is no intermediate image in a situation in which an intermediate image is to be displayed, the main image is displayed in place of the intermediate image if the recording size setting is smaller than M (or in other works, less than a predetermined size). The reason for this is as follows: In a case where the main image has a recording size setting that is smaller than M, the number of recording pixels of the main image will be equal to or less than the number of recording pixels of the intermediate image, which is a fixed value in accordance with the aspect ratio. Even though the main image is displayed, therefore, display processing equal to or greater than that for the intermediate image becomes possible and a display having a resolution higher than that of the thumbnail image can be presented without sacrificing response.

The reason for making the determination based upon the recording size setting and not the number of recording pixels of the main image or size (capacity) of the main image is as follows: Since the number of recording pixels or the data capacity of the main image differs for every aspect ratio, a comparison with the main image must be carried out for every aspect ratio. However, storing a threshold value on a per-aspect-ratio basis would put the storage capacity of the non-volatile memory 213 under strain and greater complexity would result since it would be necessary to divide up processing for every aspect ratio. Accordingly, processing is kept simple by making the determination using the recording size setting and not dividing up processing for every aspect ratio.

It should be noted that if the recording size setting is found to be L, M1 or M at step S609 mentioned above, that is, if the setting is larger than M2, the thumbnail image is displayed, and if the setting is equal to or less than M2, then the main image is displayed. Thus, the reason for making the flow split depending upon whether the recording size setting is greater than M2 or equal to or less than M2 is that M2 has a number of pixels closest to the defined number of pixels of the intermediate image. As will be described below, in each aspect ratio, the recording size setting closest to that of the intermediate image among the plurality of recording size settings is M2. In this embodiment, if the recording size setting among the plurality of recording size settings is equal to or less than M2, then the main image is displayed instead of the intermediate image. If the recording size setting is a recording size setting greater than M2, then the thumbnail image is displayed instead of the intermediate image. That is, in this embodiment, if the image is one having a number of pixels greater than the recording size of a number of pixels closest to the defined number of pixels of the intermediate image from among the plurality of recording size settings, then the intermediate image is used. Otherwise (namely a case where the size is equal to or less than the recording size of the closest number of pixels), the main image is used. It should be noted that with regard to the defined number of pixels of the intermediate image, the number is such that the upper limit on number of pixels in the horizontal direction is 1920, the upper limit on number of pixels in the vertical direction is 1080, either the number of pixels in the horizontal or vertical direction coincides with the respective upper limit on number of pixels and the number of pixels in the other direction is less than the respective upper limit on number of pixels.

<When Aspect Ratio is 4:3>

### Intermediate=1440*1080=1555200

### M1=2816*2112=5947392

### M=1984*1488=2952192

### M2=1920000

|M1−intermediate|=5947392-1555200=4392192
|M−intermediate|=2952192-1555200=1396992
|M2−intermediate|=1920000-1555200=364800

(<|M1−intermediate|, <|M−intermediate|)

That is, the number M2 of pixels is closer to the defined number of pixels of the intermediate image than is the number M1 of pixels. In other words, M2 is closest to the defined number of pixels of the intermediate image.

<When Aspect Ratio is 16:9>

### Intermediate=1920*1080=2073600

In other words, the number M2 of pixels is equal to the defined number of pixels.
In other words, M2 is closest to the defined number of pixels of the intermediate image.
<When aspect ratio is 3:2>

### Intermediate=1620*1080=1814400

### M1=2816*1880=5294080

### M2=1600*1064=1702400

|M1−intermediate|=|5294080−1814400|=3479680
|M2−intermediate|=|1702400−1814400|=112000 (<|M1−intermediate|)
That is, the number M2 of pixels is closer to the defined number of pixels of the intermediate image than is the number M1 of pixels. In other words, M2 is closest to the defined number of pixels of the intermediate image.

<When Aspect Ratio is 1:1>

### Intermediate=1080*1080=1166400

### M1=2112*2112=4460544

### M2=1200*1200=1440000

|M1−intermediate|=|4460544−1166400|=3294144
|M2−intermediate|=|1440000−1166400|=273600 (<|M1−intermediate|)
That is, the number M2 of pixels closer to the defined number of pixels of the intermediate image than is the number M1 of pixels. In other words, M2 is closest to the defined number of pixels of the intermediate image.

<When aspect ratio is 4:5>

### Intermediate=864*1080=933120

### M1=1696*2112=3581952

### M2=960*1200=1152000

|M1−intermediate|=|3581952−933120|=2648832
|M2−intermediate|=|1152000−933120|=218880 (<|M1−intermediate|)
That is, the number M2 of pixels closer to the defined number of pixels of the intermediate image than is the number M1 of pixels. In other words, M2 is closest to the defined number of pixels of the intermediate image.

### Modification 1

In the foregoing embodiment, an example is described in which it is determined whether the recording size is L, M1 or M (step S609), a thumbnail image is displayed (step S604) if the recording size is L, M1 or M, and a main image is displayed (step S602) otherwise. However, the invention is not limited to the criterion of step S609. Reference may be had to PixelDimension (309) indicating the number of recording pixels of the main image and it may be determined whether the number of recording pixels of the main image is equal to or greater than a predetermined threshold value (which is stored beforehand in the non-volatile memory 213). That is, {PixelDimension≧threshold value?} may be substituted as the criterion at step S609. If it is determined that the number of recording pixels is equal to or greater than the threshold value, process proceeds to step S604 and control is performed so as to display the thumbnail image. If the number of recording pixels is less than the threshold value, then process proceeds to step S602 and control is performed so as to display the main image. Thus, in a case where it is expected that display processing such a reading out, decompressing and decoding the main mage will take too much time and the response will decline, greater emphasis is placed on response and the thumbnail image is displayed. On the other hand, in a case where response will not decline to an extent that will cause problems, the higher-resolution main image can be displayed. A threshold value for comparison with the total number of pixels of the main image may be prepared as a predetermined threshold value, or a threshold value for comparison with the number of pixels in the vertical direction or horizontal direction of the main image, or number of pixels of the longer side or shorter side or diagonal of the main image, may be prepared as the threshold value. Further, a more ideal threshold value is one that would make it possible to determine whether the number of recording pixels of the main image is equal to or less than the number of recording pixels of the intermediate image. Accordingly, it is most preferred that the threshold value be made one that is made at least one of the total number of pixels of the intermediate image, number of pixels in the vertical direction of the intermediate image, number of pixels in the horizontal direction of the intermediate image and numbers of pixels of the longer side, shorter side and diagonal of the intermediate image. Furthermore, since an intermediate image is such that the number of recording pixels differs depending upon the aspect ratio, as mentioned above, it is most preferred that a plurality of threshold values be prepared in correlation with the aspect ratios and that a comparison be made with the threshold value that corresponds to the particular aspect ratio.

### Modification 2

The invention is not limited to the criterion at step S609. Reference may be had to Compressed data Size (311) indicating the size (data capacity) of the main image and it may be determined whether the data capacity of the main image is equal to or greater than a predetermined threshold value. That is, {Compressed data Size threshold value?} may be substituted as the criterion at step S609. If it is determined that the data capacity is equal to or greater than the threshold value, process proceeds to step S604 and control is performed so as to display the thumbnail image. If the data capacity is less than the threshold value, then process proceeds to step S602 and control is performed so as to display the main image. Thus, in a case where it is expected that display processing such a reading out, decompressing and decoding the main mage will take too much time and the response will decline, greater emphasis is placed on response and the thumbnail image is displayed. On the other hand, in a case where response will not decline to an extent that will cause problems, the higher-resolution main image can be displayed. A more ideal threshold value is one that would make it possible to determine whether the data capacity of the main image is equal to or less than the data capacity of the intermediate image. Accordingly, it is most preferred that the threshold value be made the data capacity of the intermediate image. Furthermore, since an intermediate image is such that the number of recording pixels differs depending upon the aspect ratio, as mentioned above, it is most preferred that a plurality of threshold values be prepared in correlation with the aspect ratios and that a comparison be made with the threshold value that corresponds to the particular aspect ratio.

It should be noted that control by the system control unit 201 may be implemented by a single item of hardware. Alternatively, a plurality of items of hardware may share the load of processing to thereby perform overall control of the apparatus.

Although the present invention has been described in detail based upon specific embodiments thereof, the present invention is not limited to these specific embodiments and various embodiments the scope of which does not depart from the gist of the present invention are covered by the present invention. Further, parts of the foregoing embodiments may be combined appropriately.

Further, in the foregoing embodiments, a case where the present invention is applied to a digital camera is described as one example. However, the invention is not limited to this example; if an apparatus can display an intermediate image, then the invention is applicable to such an apparatus. That is, the present invention is applicable to personal computers, PDAs, mobile telephone terminals, portable image viewers, printers having a display, digital photo albums, game machines and electronic book readers.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-286627, filed Dec. 27, 2011, which is hereby incorporated by reference herein in its entirety.

What is claimed is:

1. A display control apparatus comprising:
a reading unit configured to read an intermediate image, which has a number of recording pixels smaller than that of a main image and larger than that of a thumbnail image, from an image file; and
a display control unit configured to perform control, with regard to an image file to be displayed, in such a manner that, in a case where the intermediate image is read by said reading unit, an image based upon the read intermediate image is displayed on a display unit; and in such a manner that, in a case where the intermediate image is not read by said reading unit, an image based upon a thumbnail image included in the image file is displayed on the display unit if a main image in the image file to be displayed is equal to or greater than a predetermined size, and an image based upon the main image included in the image file is displayed on the display unit if the main image in the image file to be displayed is less than the predetermined size.

2. The apparatus according to claim 1, further comprising an acquisition unit configured to obtain information, which relates to size of a main image included in attribute information of the image file, from the image file read by said reading unit;
wherein said display control unit determines whether the main image is equal to or greater than the predetermined size based upon the information relating to size obtained by said acquisition unit.

3. The apparatus according to claim 2, wherein the information relating to size is at least one of a recording size setting, number of recording pixels and data capacity of the main image; and
in a case where number of recording pixels or data capacity is used as the information relating to size, said display control unit compares it also with aspect ratio of the main image.

4. The apparatus according to claim 2, wherein in a case where number of recording pixels is used as the information relating to size, said display control unit compares it with at least one of number of pixels in the vertical direction, number of pixels in the horizontal direction, number of pixels of a longer side, number of pixels of a shorter side and number of pixels of a diagonal, and controls display of the image based upon result of the comparison.

5. The apparatus according to claim 1, further comprising an input unit configured to accept an image scrolling operation performed by a user;
wherein said display control unit executes display control of the image in a case where a drag image scrolling operation or a continuous image scrolling operation has been carried out by said input unit.

6. The apparatus according to claim 5, wherein in a case where an image scrolling operation has been carried out by said input unit in an enlarging mode, said display control unit performs control so as to display the main image irrespective of the information relating to size.

7. The apparatus according to claim 2, wherein in a case where multiple reproduction is in progress, said display control unit performs control so as to display the thumbnail image irrespective of the information relating to size.

8. The apparatus according to claim 1, wherein the predetermined size is a size greater than a defined size of the intermediate image.

9. The apparatus according to claim 1, wherein said display control apparatus is an image capturing apparatus having an image capturing unit.

10. A method of controlling display in an apparatus which displays an image, comprising:
a reading step of reading an intermediate image, which has a number of recording pixels smaller than that of a main image and larger than that of a thumbnail image, from an image file; and
a display control step of performing control, with regard to an image file to be displayed, in such a manner that, in a case where the intermediate image is read at said reading step, an image based upon the read intermediate image is displayed on a display unit; in such a manner that, in a case where the intermediate image is not read at said reading step, an image based upon a thumbnail image included in the image file is displayed if a main image in the image file to be displayed is equal to or greater than a predetermined size, and an image based upon the main image included in the image file is displayed if the main image in the image file to be displayed is less than the predetermined size.

11. A non-transitory computer-readable storage medium storing a program for causing a computer to execute the display control method according to claim 10.
